(19) United States
(12) Patent Application Publication
(10) Pub. No.: US 2024/0220568 A1
(43) Pub. Date: Jul. 4, 2024

(54) VIDEO PLAYER INTEGRATION WITHIN WEBSITES

(71) Applicant: JBF Interlude 2009 LTD, Tel Aviv (IL)

(72) Inventors: Jonathan Bloch, Ramat HaSharon (IL); Tal Zubalsky, Brooklyn, NY (US); Yuval Hofshy, Kfar Saba (IL); Alon Benari, Brooklyn, NY (US)

(21) Appl. No.: 18/415,905

(22) Filed: Jan. 18, 2024

Related U.S. Application Data
(63) Continuation of application No. 17/484,635, filed on Sep. 24, 2021, now Pat. No. 11,934,477.

(51) Int. Cl. G06F 16/958; G06F 16/954; G06F 16/957

(52) U.S. Cl. CPC G06F 16/972; G06F 16/954; G06F 16/9577

(57) ABSTRACT

A method for presenting an interactive video to a user. The method includes providing an application layer including at least one first user interface (UI) element, providing a video player layer including at least one second UI element, the video player layer being integrated in the application layer and configured to present the interactive video to the user, receiving a first user interaction associated with the at least one first UI element, and dynamically modifying the interactive video and/or the at least one second UI element included in the video player layer based on the first user interaction.

### CROSS-REFERENCE TO RELATED APPLICATIONS

This application is a Continuation of U.S. application Ser. No. 17/484,635 filed on Sep. 24, 2021, which is hereby incorporated by reference in its entirety.

### TECHNICAL FIELD

The following disclosure is directed to methods and systems for presenting interactive videos and, more specifically, presenting interactive videos using an interactive video player integrated within websites.

### BACKGROUND

Websites often present information about a given product for the purpose of selling the product to a customer of the website. Some of these websites include videos visually presenting the product (e.g., a new vehicle, a power tool, a toy, a bouquet of flowers, etc.). However, such videos are typically predetermined and unalterable by the video developer or the user.

### SUMMARY

At least one aspect of the present disclosure is directed to a method for presenting an interactive video to a user. The method includes providing an application layer including at least one first user interface (UI) element, providing a video player layer including at least one second UI element, the video player layer being integrated in the application layer and configured to present the interactive video to the user, receiving a first user interaction associated with the at least one first UI element, and dynamically modifying the interactive video and/or the at least one second UI element included in the video player layer based on the first user interaction.

In one embodiment, the application layer and the video player layer are configured to communicate via an application program interface (API). In some embodiments, the method includes sending, via the API, at least one message from the application layer to the video player layer corresponding to the first user interaction. In various embodiments, the interactive video includes a video tree having a plurality of nodes and the at least one message corresponds to a selected node of the plurality of nodes. In certain embodiments, dynamically modifying the interactive video includes seeking to the selected node and presenting video content associated with the selected node to the user.

In some embodiments, the application layer is configured to present webpage content to the user. In one embodiment, the method includes receiving a second user interaction associated with the at least one second UI element, and dynamically modifying the webpage content and/or the at least one first UI element included in the application layer based on the second user interaction. In certain embodiments, the method includes sending, via the API, at least one message from the video player layer to the application layer corresponding to the second user interaction. In various embodiments, the method includes sending, via the API, an event list including a plurality of events from the application layer to the video player layer, and sending, via the API, at least one message from the video player layer to the application layer in response to the occurrence of at least one event of the plurality of events.

In one embodiment, the at least one first UI element includes at least one first button and the at least one second UI element includes at least one second button.

Another aspect of the present disclosure is directed to a system for presenting an interactive video to a user. The system includes at least one memory for storing computer-executable instructions, and at least one processor for executing the instructions stored on the memory, wherein execution of the instructions programs the at least one processor to perform operations comprising: providing an application layer including at least one first user interface (UI) element, providing a video player layer including at least one second UI element, the video player layer being integrated in the application layer and configured to present the interactive video to the user, receiving a first user interaction associated with the at least one first UI element, and dynamically modifying the interactive video and/or the at least one second UI element included in the video player layer based on the first user interaction.

In one embodiment, the application layer and the video player layer are configured to communicate via an API. In some embodiments, the operations include sending, via the API, at least one message from the application layer to the video player layer corresponding to the first user interaction. In various embodiments, the interactive video includes a video tree having a plurality of nodes and the at least one message corresponds to a selected node of the plurality of nodes. In certain embodiments, dynamically modifying the interactive video includes seeking to the selected node and presenting video content associated with the selected node to the user.

In some embodiments, the application layer is configured to present webpage content to the user. In one embodiment, the operations include receiving a second user interaction associated with the at least one second UI element, and dynamically modifying the webpage content and/or the at least one first UI element included in the application layer based on the second user interaction. In certain embodiments, the operations include sending, via the API, at least one message from the video player layer to the application layer corresponding to the second user interaction. In various embodiments, the operations include sending, via the API, an event list including a plurality of events from the application layer to the video player layer, and sending, via the API, at least one message from the video player layer to the application layer in response to the occurrence of at least one event of the plurality of events.

In one embodiment, the at least one first UI element includes at least one first button and the at least one second UI element includes at least one second button.

Further aspects and advantages of the invention will become apparent from the following drawings, detailed description, and claims, all of which illustrate the principles of the invention, by way of example only.

### BRIEF DESCRIPTION OF THE DRAWINGS

A more complete appreciation of the invention and many attendant advantages thereof will be readily obtained as the same becomes better understood by reference to the following detailed description when considered in connection with the accompanying drawings. In the drawings, like reference characters generally refer to the same parts throughout the different views. Further, the drawings are not necessarily to scale, with emphasis instead generally being placed upon illustrating the principles of the invention.

FIG. 1 depicts a high-level system architecture for providing interactive media content according to an implementation.

FIG. 2 is a flowchart of an example method for generating an interactive video on an automated platform.

FIG. 3 is a diagram of an example system including the automated platform.

FIG. 4A is a diagram illustrating example module types for use in the example system of FIG. 3.

FIG. 4B is a diagram of an example project formed from five modules.

FIG. 4C is a diagram of an example template for an interactive video.

FIG. 5A is a diagram of an example template organized serially for selecting features of a particular product.

FIG. 5B is a diagram of a tree structure associated with the example template of FIG. 5A.

FIG. 6A is a diagram of an example template in which an interactive video enables multiple items to be selected.

FIG. 6B provides a shopping list that may be compiled based on the end user selections made in the interactive video of FIG. 6A.

FIG. 7A is a diagram illustrating the adding of buttons into an example interactive video.

FIG. 7B is a diagram illustrating the adding of sections into an example interactive video.

FIG. 7C is a diagram illustrating a section of video content added in a time-arranged sequence.

FIG. 8 is a diagram illustrating an integrated video player.

FIG. 9 is a diagram illustrating a user interaction sequence corresponding to the integrated video player of FIG. 8.

FIG. 10 is a diagram illustrating several orientations of a client device displaying the integrated video player of FIG. 8.

FIG. 11A is a diagram illustrating a communication sequence between an application layer and a video player layer of the integrated video player of FIG. 8.

FIG. 11B is a diagram illustrating a communication sequence between an application layer and a video player layer of the integrated video player of FIG. 8.

FIG. 12 is a diagram illustrating an analytics platform including the integrated video player of FIG. 8.

### DETAILED DESCRIPTION

Disclosed herein are exemplary embodiments of systems and methods for presenting interactive videos. In particular, described are various embodiments of an interactive video player integrated within websites.

### High-Level System Architecture

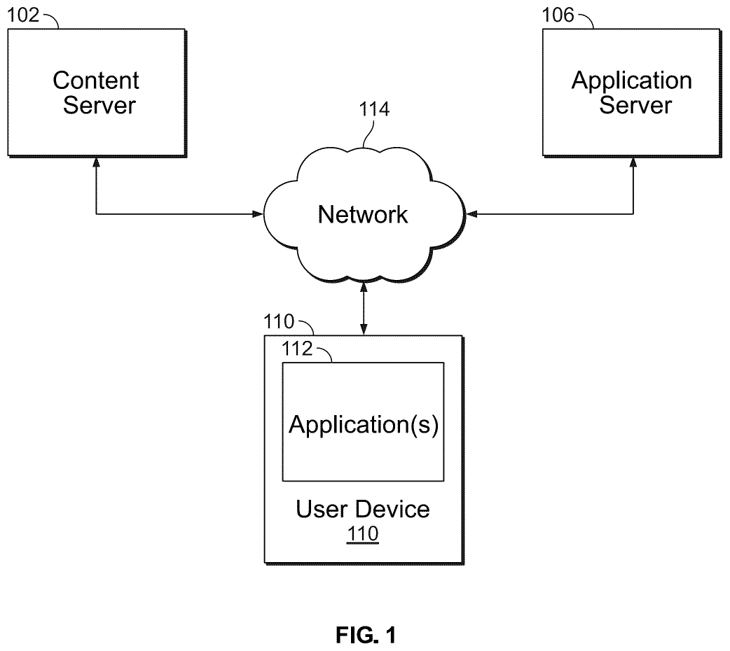

FIG. 1 depicts a high-level architecture of such a system according to an implementation. A media presentation having multiple video and/or audio streams can be presented to a user on a user device 110 having one or more application(s) 112 that together are capable of playing and/or editing the content and displaying a video library where information associated with videos can browsed and videos can be selected for playback. The user device 110 can be, for example, a smartphone, tablet, laptop, desktop, palmtop, television, gaming device, virtual reality headset, smart glasses, smart watch, music player, mobile telephone, workstation, or other computing device configured to execute the functionality described herein. The user device 110 can have output functionality (e.g., display monitor, touchscreen, image projector, etc.) and input functionality (e.g., touchscreen, keyboard, mouse, remote control, etc.).

The application 112 can be a video player/editor and library browser that is implemented as a native application, web application, or other form of software. In some implementations, the application 112 is in the form of a web page, widget, and/or Java, JavaScript, .Net, Silverlight, Flash, and/or other applet or plug-in that is downloaded to the user device 110 and runs in conjunction with a web browser. The application 112 and the web browser can be part of a single client-server interface; for example, the application 112 can be implemented as a plugin to the web browser or to another framework or operating system. Any other suitable client software architecture, including but not limited to widget frameworks and applet technology, can also be employed.

Media content can be provided to the user device 110 by content server 102, which can be a web server, media server, a node in a content delivery network, or other content source. In some implementations, the application 112 (or a portion thereof) is provided by application server 106. For example, some or all of the described functionality of the application 112 can be implemented in software downloaded to or existing on the user device 110 and, in some instances, some or all of the functionality exists remotely. For example, certain video encoding and processing functions can be performed on one or more remote servers, such as application server 106. In some implementations, the user device 110 serves only to provide output and input functionality, with the remainder of the processes being performed remotely.

The user device 110, content server 102, application server 106, and/or other devices and servers can communicate with each other through communications network 114. The communication can take place via any media such as standard telephone lines, LAN or WAN links (e.g., T1, T3, 56 kb, X.25), broadband connections (ISDN, Frame Relay, ATM), wireless links (802.11, Bluetooth, GSM, CDMA, etc.), and so on. The network 114 can carry TCP/IP protocol communications and HTTP/HTTPS requests made by a web browser, and the connection between clients and servers can be communicated over such TCP/IP networks. The type of network is not a limitation, however, and any suitable network can be used.

More generally, the techniques described herein can be implemented in any suitable hardware or software. If implemented as software, the processes can execute on a system capable of running one or more custom operating systems or commercial operating systems such as the Microsoft Windows® operating systems, the Apple OS X® operating systems, the Apple iOS® platform, the Google Android™ platform, the Linux® operating system and other variants of UNIX® operating systems, and the like. The software can be implemented a computer including a processing unit, a system memory, and a system bus that couples various system components including the system memory to the processing unit.

The system can include a plurality of software modules stored in a memory and executed on one or more processors. The modules can be in the form of a suitable programming language, which is converted to machine language or object code to allow the processor or processors to read the instructions. The software can be in the form of a standalone application, implemented in any suitable programming language or framework.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. One or more memories can store media assets (e.g., audio, video, graphics, interface elements, and/or other media files), configuration files, and/or instructions that, when executed by a processor, form the modules, engines, and other components described herein and perform the functionality associated with the components. The processor and the memory can be supplemented by, or incorporated in special purpose logic circuitry.

It should also be noted that the present implementations can be provided as one or more computer-readable programs embodied on or in one or more articles of manufacture. The article of manufacture can be any suitable hardware apparatus, such as, for example, a floppy disk, a hard disk, a CD-ROM, a CD-RW, a CD-R, a DVD-ROM, a DVD-RW, a DVD-R, a flash memory card, a PROM, a RAM, a ROM, or a magnetic tape. In general, the computer-readable programs can be implemented in any programming language. The software programs can be further translated into machine language or virtual machine instructions and stored in a program file in that form. The program file can then be stored on or in one or more of the articles of manufacture.

### Media Presentations

The media presentations referred to herein can be structured in various forms. For example, a particular media presentation can be an online streaming video having multiple tracks or streams that a user can switch among in real-time or near real-time. For example, a media presentation can be structured using parallel audio and/or video tracks as described in U.S. patent application Ser. No. 14/534,626, filed on Nov. 6, 2014, and entitled “Systems and Methods for Parallel Track Transitions,” the entirety of which is incorporated by reference herein. More specifically, a playing video file or stream can have one or more parallel tracks that can be switched among in real-time automatically and/or based on user interactions. In some implementations, such switches are made seamlessly and substantially instantaneously, such that the audio and/or video of the playing content can continue without any perceptible delays, gaps, or buffering. In further implementations, switches among tracks maintain temporal continuity; that is, the tracks can be synchronized to a common timeline so that there is continuity in audio and/or video content when switching from one track to another (e.g., the same song is played using different instruments on different audio tracks; same storyline performed by different characters on different video tracks, and the like).

Such media presentations can also include interactive video structured in a video tree, hierarchy, or other form. A video tree can be formed by nodes that are connected in a branching, hierarchical, or other linked form. Nodes can each have an associated video segment, audio segment, graphical user interface (GUI) elements, and/or other associated media. Users (e.g., viewers) can watch a video that begins from a starting node in the tree and proceeds along connected nodes in a branch or path. Upon reaching a point during playback of the video where multiple video segments (child nodes) branch off from a segment (parent node), the user can interactively select the branch or path to traverse and, thus, the next video segment to watch.

As referred to herein, a particular branch or path in an interactive media structure, such as a video tree, can refer to a set of consecutively linked nodes between a starting node and ending node, inclusively, or can refer to some or all possible linked nodes that are connected subsequent to (e.g., sub-branches) or that include a particular node. Branched video can include seamlessly assembled and selectably presentable multimedia content such as that described in U.S. patent application Ser. No. 13/033,916, filed on Feb. 24, 2011, and entitled “System and Method for Seamless Multimedia Assembly” (the “Seamless Multimedia Assembly application”), and U.S. patent application Ser. No. 14/107,600, filed on Dec. 16, 2013, and entitled “Methods and Systems for Unfolding Video Pre-Roll,” the entireties of which are hereby incorporated by reference.

The prerecorded video segments in a video tree or other structure can be selectably presentable multimedia content; that is, some or all of the video segments in the video tree can be individually or collectively played for a user based upon the user's selection of a particular video segment, an interaction with a previous or playing video segment, or other interaction that results in a particular video segment or segments being played. The video segments can include, for example, one or more predefined, separate multimedia content segments that can be combined in various manners to create a continuous, seamless presentation such that there are no noticeable gaps, jumps, freezes, delays, or other visual or audible interruptions to video or audio playback between segments. In addition to the foregoing, “seamless” can refer to a continuous playback of content that gives the user the appearance of watching a single, linear multimedia presentation, as well as a continuous playback of multiple content segments that have smooth audio and/or video transitions (e.g., fadeout/fade-in, linking segments) between two or more of the segments.

In some instances, the user is permitted to make choices or otherwise interact in real-time at decision points or during decision periods interspersed throughout the multimedia content. Decision points and/or decision periods can occur at any time and in any number during a multimedia segment, including at or near the beginning and/or the end of the segment. Decision points and/or periods can be predefined, occurring at fixed points or during fixed periods in the multimedia content segments. Based at least in part on the user's choices made before or during playback of content, one or more subsequent multimedia segment(s) associated with the choices can be presented to the user. In some implementations, the subsequent segment is played immediately and automatically following the conclusion of the current segment, whereas in other implementations, the subsequent segment is played immediately upon the user's interaction with the video, without waiting for the end of the decision period or the end of the segment itself.

If a user does not make a selection at a decision point or during a decision period, a default, previously identified selection, or random selection can be made by the system. In some instances, the user is not provided with options; rather, the system automatically selects the segments that will be shown based on information that is associated with the user, other users, or other factors, such as the current date. For example, the system can automatically select subsequent segments based on the user's IP address, location, time zone, the weather in the user's location, social networking ID, saved selections, stored user profiles, preferred products or services, and so on. The system can also automatically select segments based on previous selections made by other users, such as the most popular suggestion or shared selections. The information can also be displayed to the user in the video, e.g., to show the user why an automatic selection is made. As one example, video segments can be automatically selected for presentation based on the geographical location of three different users: a user in Canada will see a twenty-second beer commercial segment followed by an interview segment with a Canadian citizen; a user in the US will see the same beer commercial segment followed by an interview segment with a US citizen; and a user in France is shown only the beer commercial segment.

Multimedia segment(s) selected automatically or by a user can be presented immediately following a currently playing segment, or can be shown after other segments are played. Further, the selected multimedia segment(s) can be presented to the user immediately after selection, after a fixed or random delay, at the end of a decision period, and/or at the end of the currently playing segment. Two or more combined segments can form a seamless multimedia content path or branch, and users can take multiple paths over multiple playthroughs, and experience different complete, start-to-finish, seamless presentations. Further, one or more multimedia segments can be shared among intertwining paths while still ensuring a seamless transition from a previous segment and to the next segment. The content paths can be predefined, with fixed sets of possible transitions in order to ensure seamless transitions among segments. The content paths can also be partially or wholly undefined, such that, in some or all instances, the user can switch to any known video segment without limitation. There can be any number of predefined paths, each having any number of predefined multimedia segments. Some or all of the segments can have the same or different playback lengths, including segments branching from a single source segment.

Traversal of the nodes along a content path in a tree can be performed by selecting among options that appear on and/or around the video while the video is playing. In some implementations, these options are presented to users at a decision point and/or during a decision period in a content segment. Some or all of the displayed options can hover and then disappear when the decision period ends or when an option has been selected. Further, a timer, countdown or other visual, aural, or other sensory indicator can be presented during playback of content segment to inform the user of the point by which he should (or, in some cases, must) make his selection. For example, the countdown can indicate when the decision period will end, which can be at a different time than when the currently playing segment will end. If a decision period ends before the end of a particular segment, the remaining portion of the segment can serve as a non-interactive seamless transition to one or more other segments. Further, during this non-interactive end portion, the next multimedia content segment (and other potential next segments) can be downloaded and buffered in the background for later playback (or potential playback). A segment that is played after (immediately after or otherwise) a currently playing segment can be determined based on an option selected or other interaction with the video. Each available option can result in a different video and audio segment being played. As previously mentioned, the transition to the next segment can occur immediately upon selection, at the end of the current segment, or at some other predefined or random point. Notably, the transition between content segments can be seamless. In other words, the audio and video continue playing regardless of whether a segment selection is made, and no noticeable gaps appear in audio or video playback between any connecting segments. In some instances, the video continues on to another segment after a certain amount of time if none is chosen, or can continue playing in a loop.

In one example, the multimedia content is a music video in which the user selects options upon reaching segment decision points to determine subsequent content to be played. First, a video introduction segment is played for the user. Prior to the end of the segment, a decision point is reached at which the user can select the next segment to be played from a listing of choices. In this case, the user is presented with a choice as to who will sing the first verse of the song: a tall, female performer, or a short, male performer. The user is given an amount of time to make a selection (i.e., a decision period), after which, if no selection is made, a default segment will be automatically selected. The default can be a predefined or random selection. Of note, the media content continues to play during the time the user is presented with the choices. Once a choice is selected (or the decision period ends), a seamless transition occurs to the next segment, meaning that the audio and video continue on to the next segment as if there were no break between the two segments and the user cannot visually or audibly detect the transition. As the music video continues, the user is presented with other choices at other decisions points, depending on which path of choices is followed. Ultimately, the user arrives at a final segment, having traversed a complete multimedia content path.

### Interactive Videos for Physical Items

In various embodiments, interactive videos may feature one or more physical items, e.g., for the purpose of selling the item, for educating a user about the item, for training a user about the item, etc. Example embodiments of the interactive videos may enable a user to interact with a representation of an item. In some embodiments, the interactive video may be configured such that the user is able to interact with the representation of the item within the video, outside of the video, adjacent to the video, etc.

For example, in the context of a product on sale (e.g., a car, a shirt, gym equipment, etc.), the video featuring the product may be configured to enable a user to interact with the representation of the product, the product's features, types of the product, options for the product, accessories for the product, other products similar and/or related to the product, etc. In this way, the user can explore and learn more about the product before making a purchasing decision. In another example, in the context of an educational video featuring a subject item, the video may be configured to present a representation of the subject item (e.g., a whale, a circuit, a plant, a book, etc.). The user (e.g., student, trainee, etc.) can interact with the subject item to learn more about and/or investigate the features of the subject item, reconfigurability of the item, etc. It is understood that, while this disclosure features systems and methods for generating interactive videos for products, the example systems and methods described herein can be applied to interactive videos featuring educational items, training items, items subject to investigation, items subject to analysis, etc.

In various embodiments, the interactive video can be included (integrated, embedded, etc.) in a website, an app for a mobile device, on an automated platform, etc. For example, the interactive video featuring a product may be on the product-specific webpage or a product detail page (PDP) of the app or platform. In another example, the interactive video can be part of a retail website (e.g., Nike.com, Toyota.com, Samsung.com, etc.) or a part of an online marketplace (e.g., Walmart.com, Amazon.com, etc.).

### Automated Platform and Related Methods

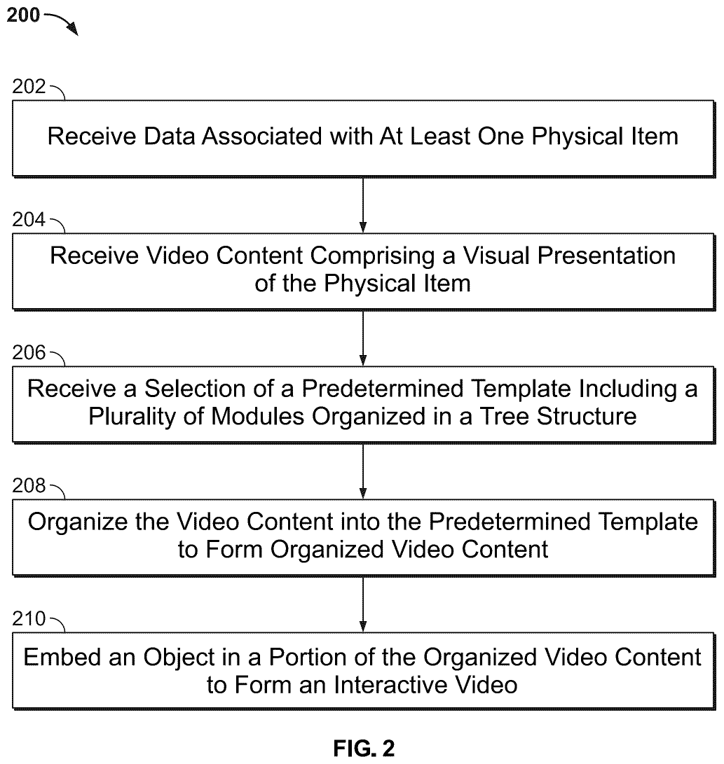

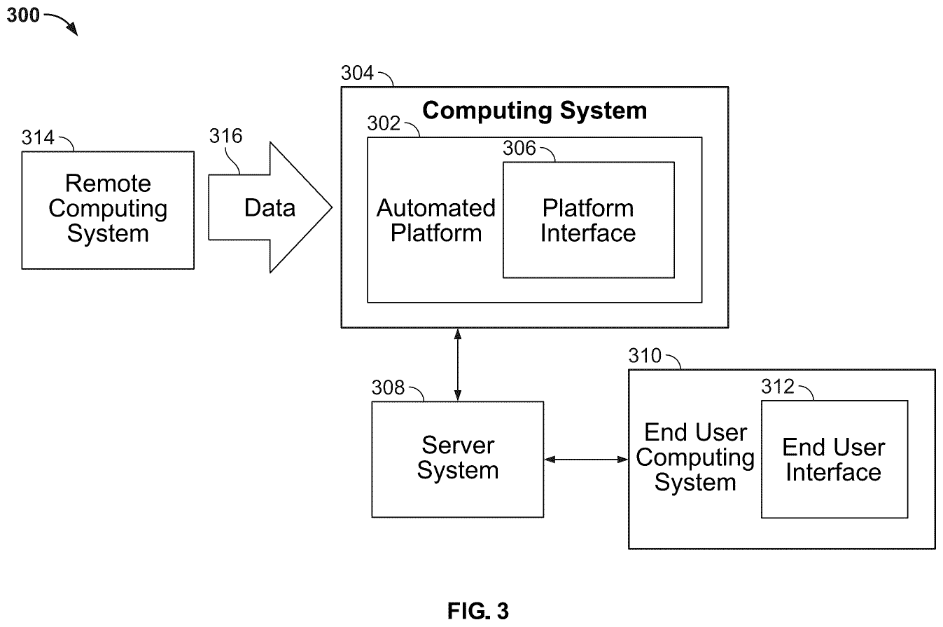

In various embodiments, an automated platform can be configured to generate an interactive video. FIG. 2 shows a flowchart of an example method for generating an interactive video on an automated platform. FIG. 3 illustrates a diagram of an example system including the automated platform. For the sake of clarity and conciseness, FIGS. 2-3 are discussed together herein. The term “publisher” is used to refer to the user that is involved in generating the interactive videos and the term “end user” is used to refer to the user that interacts with the interactive videos.

Referring to FIG. 3, the example system 300 may include an automated platform 302 hosted on a computing system 304. In some embodiments, the automated platform 302 includes a platform interface 306. A server system 308 may be configured to be connected (e.g., via an API, via the cloud, a computer network, etc.) to the computing system 304. The server system 308 may be configured to be connected (e.g., via an API, via the cloud, a computer network, etc.) to an end user computing system 310. The end user computing system 310 may have an end user interface 312. The end user computing system 310 may be a mobile device, a smartphone, a tablet computer, a laptop computer, a notebook computer, a set of smart glasses, a smart watch, a headset, etc. Note that the system 300 may be communicably connected (e.g., via an API, via the cloud, a computer network, etc.) to other computing systems, e.g., remote computing system 314.

In step 202, the system 300 (e.g., automated platform 302) can be configured to receive data 316 associated with at least one physical item. The received data 316 may be streamed, received via an application programming interface (API), received in one or more data files, and/or received in a bulk data transfer. The received data 316 to may be inputted by the publisher and/or obtained from a remote computing system 314. For example, the data 316 may include an identification number or code associated the item (e.g., a stock keeping unit (SKU), an ID number, etc.), a link to a website (e.g., a URL) associated with the item, a text description associated with the item, one or more tags associated with the item, a list of features associated with the item, one or more images of the item, one or more videos associated with the item, one or more videos associated with the item feature, one or more audio data associated with the item, and/or one or more audio data associated with the item features. For example, the received data 316 for a particular product may include a product name, one or more pictures of the product, customer reviews of the product, a product description, inventory status, one or more tags, an identification number, etc. As described further below, one or more of these data may be used or presented in or adjacent to the interactive video featuring the product item.

In step 204, the system 300 can be configured to receive video content including a visual presentation of one or more physical items. In some embodiments, the interactive video features one item. In some embodiments, the interactive video features two or more options (e.g., color, size, similar products, etc.) for the same item. In some embodiments, the interactive video features two or more items. For example, an interactive video can feature a cooking video with a grocery shopping list of ingredients used in the video. In another example, an interactive video for skiing or snowboarding can feature multiple pieces of clothing, equipment, accessories, etc. for purchase.

In step 206, the system 300 can be configured to receive a selection of a predetermined template. The predetermined template may include two or more modules (also referred to as “sections”) organized in a tree structure. Note that the system 300 may store and/or reference one or more templates based on the item, a feature of the item, a tag associated with the item, the publisher's preference, etc. Different templates may be associated with different tree structures, may have different appearances, and/or accommodate different data (e.g., video, audio, etc.) associated with the item. The publisher can select an appropriate template for a given item; add, remove, or adjust modules; adjust the associated tree structure; add, remove, or adjust the data in the template.

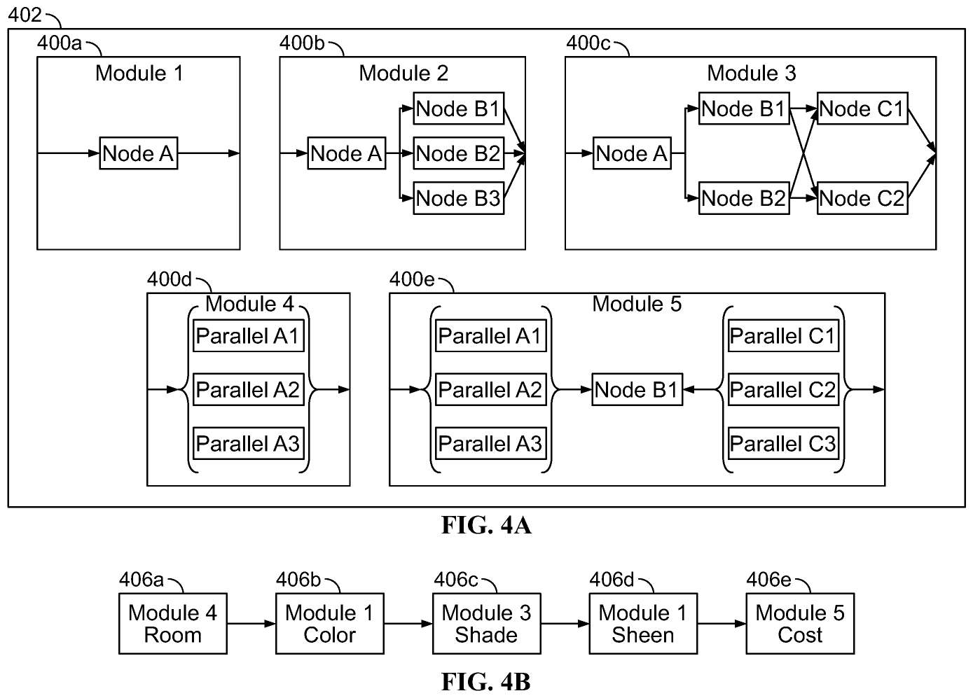

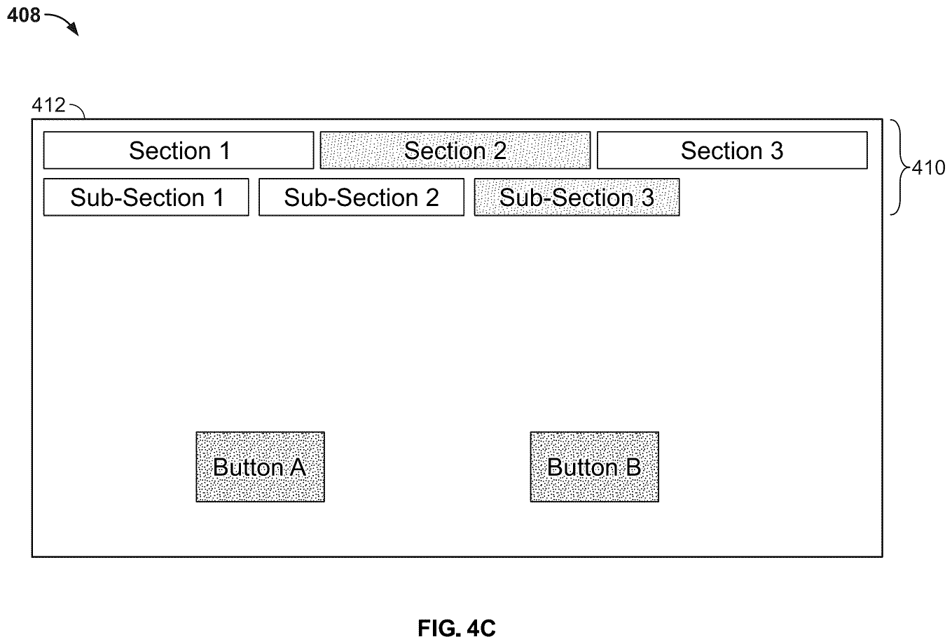

FIG. 4A illustrates example module types for use in system 300. A given module may include one or more nodes arranged in a tree structure. Illustrated are module type 1 (400a), module type 2 (module 400b), module type 3 (module 400c), module type 4 (module 400d), and module type 5 (module 400e) (collectively referred as module types 400). It is understood that other types and/or configurations of modules are within the scope of this disclosure. For instance, module type 1 may include a single node A having an input (connected to the input of the module 400a) and an output (connected to the output of the module 400a). Module type 2 may include node A having an input (connected to the input to the module 400b) and an output connected to the inputs of nodes B1, B2, and B3. Nodes B1, B2, and B3 can be arranged in parallel. The outputs of nodes B1, B2, and B3 can form the output of module 400b. Module type 3 may include a node A having an input (connected to the input of the module 400c) and an output connected to the inputs of node B1 and node B2 (which can be arranged in parallel to one another). The outputs of node B1 and node B2 can be connected to the inputs of node C1 and node C2. The outputs of node C1 and node C2 can be connected to the output of module 400c. Module type 4 may include parallel node A1, node A2, and node A3. The input of module 400d can be connected to one or more of the parallel nodes and the output of one or more of the parallel nodes can be connected to the output of the module 400d. Module type 5 can include parallel node A1, node A2, and node A3. The input of module 400e can be connected to one or more of the parallel nodes A1, A2, A3. The output of one or more of the parallel nodes can be connected to the input of node B1. The output of node B1 can be connected to one or more of the inputs of parallel nodes C1, C2, C3. The outputs of parallel nodes C1, C2, C3 can be connected to the output of module 400e. In various embodiments, one or more modules 400 of types 1-5 can be part of a project workspace 402. These modules 400 can be selected and/or organized by a user (e.g., a publisher) working in the project workspace 402.

FIG. 4B illustrates an example project 404 formed from five modules. In this example, the project 404 is for an interactive video enabling the selection of a wall paint. The project includes module 406a (of type 4) enabling the selection of a room (e.g., in a residence); module 406b (of type 1) enabling the selection of a color; module 406c (of type 3) enabling the selection of a shade; module 406d (of type 1) enabling the selection of a sheen; and module 406e (of type 5) enabling the selection of cost.

FIG. 4C illustrates an example template 408. As illustrated, the template 408 includes an index of sections at the top 410 of the frame 412. The interactive video may play inside the frame 412 as it is being configured for interactivity. The example template 408 may include two or more sections (e.g., Section 1, Section 2, Section 3), two or more sub-sections (e.g., Sub-Section 1, Sub-Section 2, Sub-Section 3), and two or more buttons (e.g., Button A, Button B). The sections and/or the subsections can each be associated with a particular interactive aspect of the video. The buttons can be configured by the publisher to enable a user select a feature or option in the interactive video.

In step 208, the system 300 can be configured to organize the video content into the predetermined template to form organized video template. In some embodiments, the video content may be received in portions and/or divided into portions after receipt. These video content portions may be organized into sections (and/or subsections). For example, a template for an interactive video featuring a toy may organize received video content such that the interactive video includes a first section for unboxing the toy, a second section for playing with the toy, and exploring the features of the toy. In another example, a template for an interactive video featuring a fashion product (e.g., clothes, accessories, shoes, etc.) may include a first section for the user to select a fashion influencer, a second section to view a product associated with the influencer, a third section to select a color, and a fourth section to select a color.

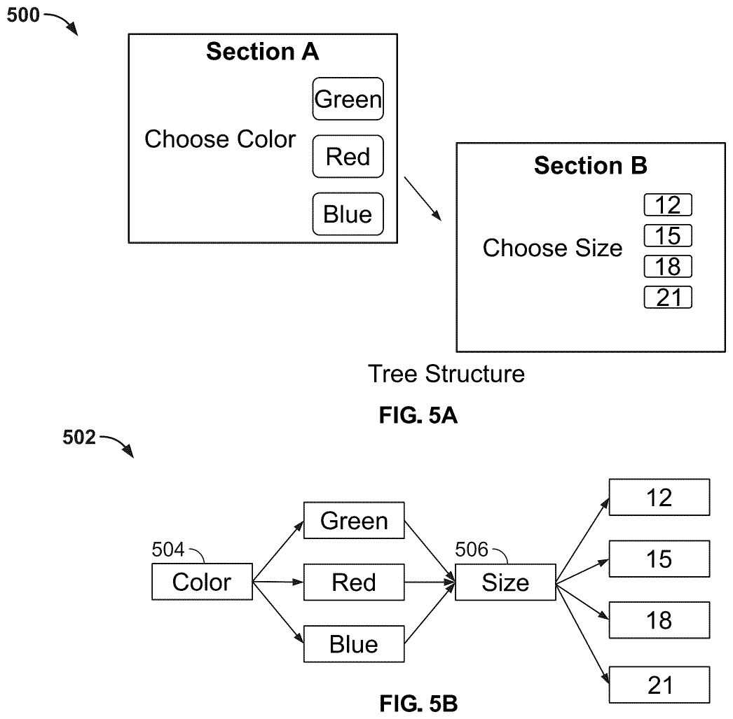

In step 210, an object (e.g., a button, an interactive element, a slide, etc.) may be embedded in a portion of the video content (e.g., in a section) to enable the end user to interact with the video. FIG. 5A illustrates example template 500 (or part of a template) organized serially (e.g., sequentially, in time, etc.) for selecting features of a particular product (e.g., item of clothing). The template 500 includes a first section (Section A) in which the end user is prompted to select a color of the product (e.g., green, red, or blue) and a second section (Section B) in which the end user is prompted to select a size of the product (e.g., 12, 15, 18, 21). As illustrated in FIG. 5B, the tree structure 502 is arranged such that the color branch 504 splits into three branches (one for each color green, red, blue). The color branches lead to the size branch 506, which splits into four branches (one for size 12, size 15, size 18, and size 21).

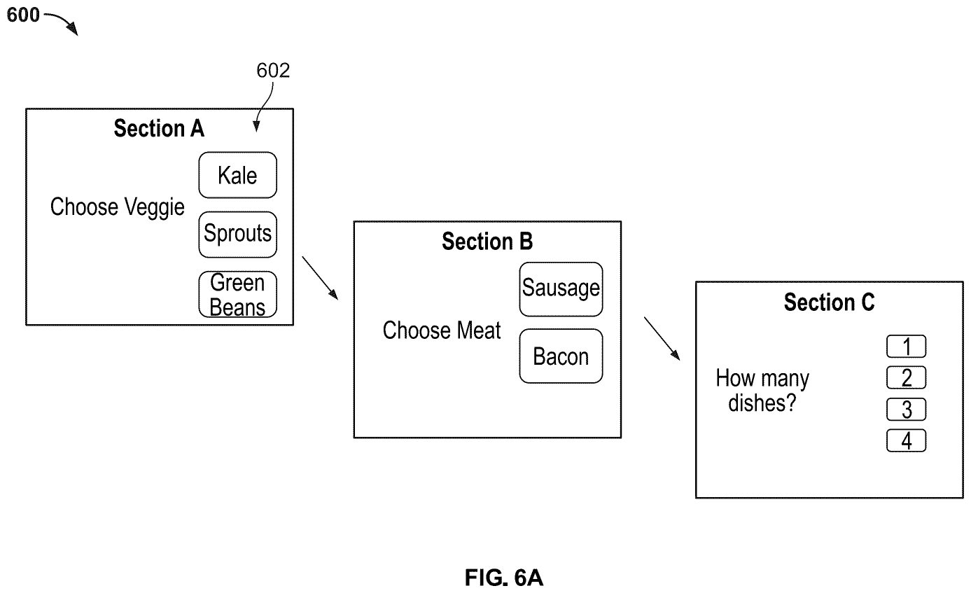

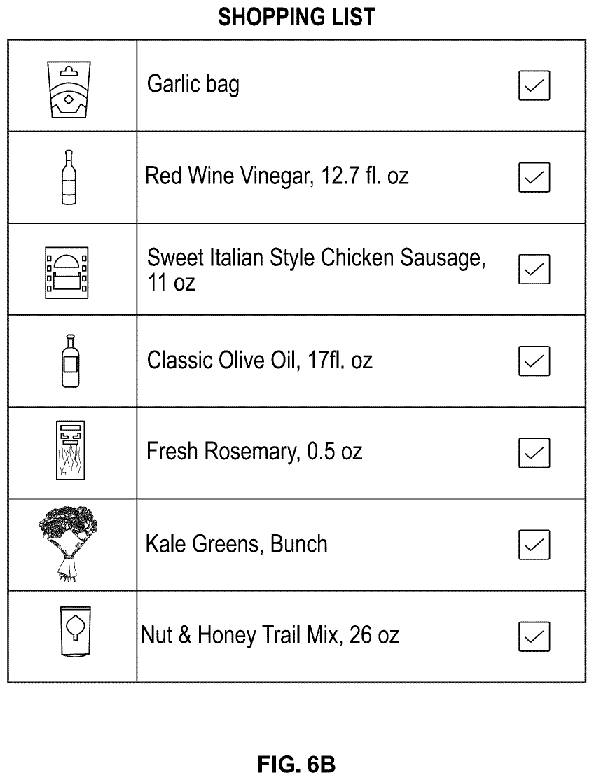

FIG. 6A provides an example template 600 in which an interactive video enables multiple items to be selected. In this example, each section may include a video content portion associated with a food (e.g., a segment of a cooking video in which one or more ingredients are added). Therefore, in Section A, a video portion (e.g., associated with a vegetable component) may play and buttons (e.g., to types of vegetables respectively) may appear before, during, or after the video portion plays. Once a selection is made (e.g., button “Kale”), the interactive video moves to the next section having the next video content portion (e.g., associated with a meat component). Again, a selection of a button (e.g., sausage) is made and the video content in Section C is played. Note that this sequence may include more or less sections. The sections may be of different lengths. For example, FIG. 6B provides a shopping list that may be compiled based on the end user selections made in previous sections. It is understood that a similar list may be compiled based on an interactive video for winter sports equipment, a car with trim options, a product with various configurations, etc.

In some embodiments, the interactive video may be configured to wait for end user interaction (e.g., via a button) to move to the next section. In some embodiments, the interactive video may be configured to automatically select a button for the end user after some time period (or make no selection) and move to the next section.

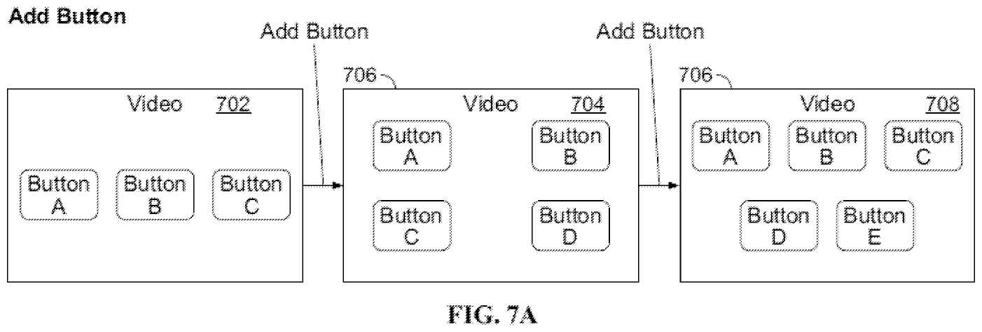

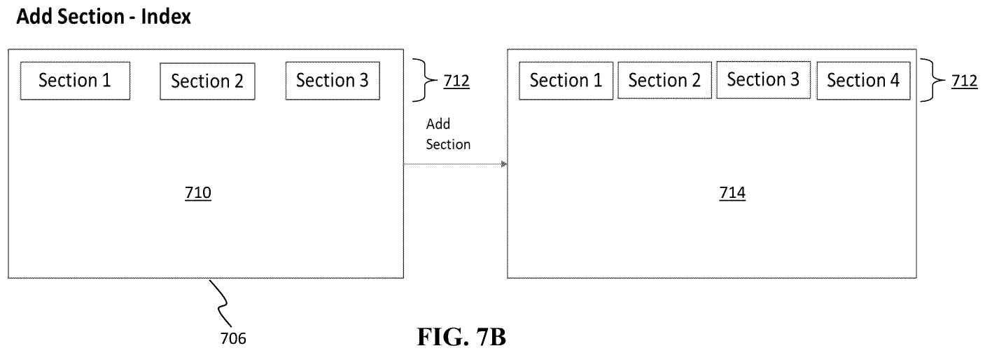

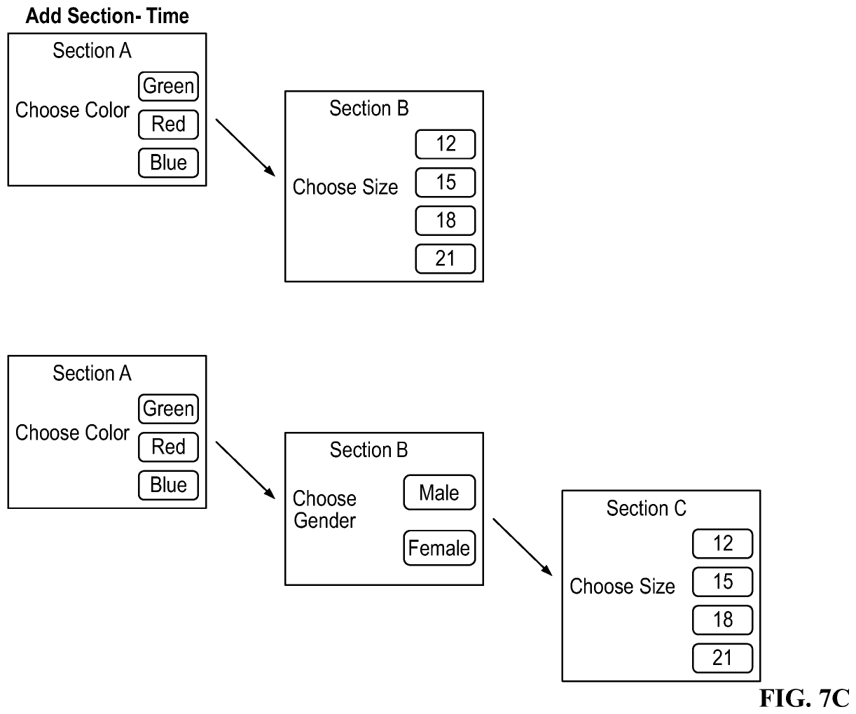

In some embodiments, the interactive video may be altered before, during, or after the video is “live” on a website. For example, one or more aspects of the template and/or the video content (e.g., buttons, sections, subsections, timeline, video content, data) may be adjusted. FIG. 7A illustrates the adding of buttons into an interactive video 702. In this example, interactive video 702 includes buttons A, B, and C. The publisher can add a button D to create 704. In some embodiments, the template is configured to enable the buttons A, B, C, and D to distribute automatically based on their number over the area inside the frame 706. Adding a button to video 704 causes the arrangement displayed in video 708, in which the five buttons are distributed in the frame 706. In some embodiments, this predetermined distribution of buttons is adjustable by the publisher. Note that the buttons described herein may be positioned anywhere within a frame (e.g., of the interactive video, of the player of the video, etc.), at the perimeter of the video, outside the video on the webpage.

In FIG. 7B, the publisher can choose to add or subtract sections from an interactive video 710. In the illustrated example, the publisher has added a fourth section, which is added to the index at the top of the frame 712 to form interactive video 714. FIG. 7C illustrates an embodiment in which a section of video content is added in a time-arranged sequence. In particular, in interactive video 716, Section A (selecting a color of the item) passes to Section B (selecting a size of the item). The platform 302 enables the publisher to add a section between Sections A and B. For example, a new Section B (selecting a gender) is added between selecting a color in Section A and selecting a size in new Section C (old Section B). Note that the changes described herein to the interactive video has a corresponding effect in the tree structure for the interactive video.

In some embodiments, a template for an interactive video may be embedded into a website and may be configured to be “overridden” by data associated with the webpage. For instance, the template can include placeholder sections, buttons, fields, video content, images, number of template elements (e.g., sections, subsections, buttons, etc.), location of elements, etc. The template may then be overridden by the website in real time or near real time. The features of the template that can be overridden may be included in metadata associated with the template and/or webpage carrying the template. A publisher may choose to embed the template into multiple webpages (e.g., each webpage featuring a different model of a shoe, an online marketplace featuring a wide variety of products, etc.) and override the template with content and/or configurations specific to the item on that webpage. In some embodiments, the configuration of template, video content, and/or related data can be stored within data of the webpage.

### Integrated Video Player

As described above, the interactive video can be embedded into a webpage such that users can interact with the interactive video while browsing or viewing the webpage. However, when embedded into the webpage, there may be a disconnect between the content on the webpage and user interactions with the interactive video. As such, it may be advantageous to integrate the interactive video into the webpage such that interactive video and/or the webpage can be dynamically updated based on the user interactions.

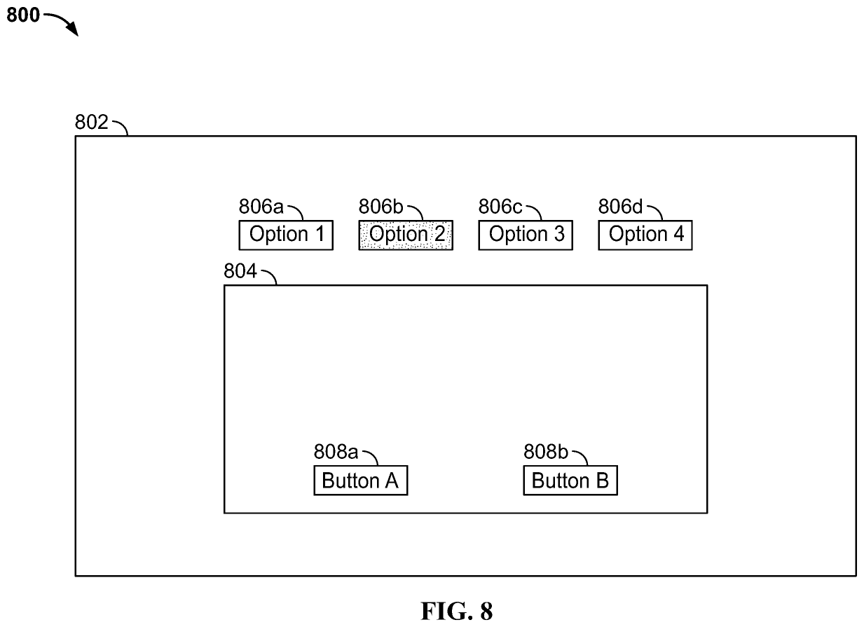

FIG. 8 illustrates a diagram of an integrated video player 800 in accordance with aspects described herein. In one example, the integrated video player includes an application layer 802 and a video player layer 804. In some examples, the application layer 802 corresponds to a webpage or website; however, in other examples, the application layer may correspond to the user interface of a client application (e.g., a mobile application). As such, the application layer 802 includes text, graphics, and other user interface features associated with the website (or application). The application layer 802 may be an HTML document. The video player layer 804 is configured to display an interactive video or an interactive video template (e.g., template 408 of FIG. 4C). In some examples, the video player layer 804 corresponds to an inline frame (iFrame). In one example, the video player layer 804 is an HTML document embedded inside another HTML document (e.g., the application layer 802).

The application layer 802 and the video player layer 804 can include user interface (UI) elements that enable users to interact with the webpage and/or the interactive video. For example, the application layer 802 includes a first plurality of UI elements 806 and the video player layer 804 includes a second plurality of UI elements 808. In one example, the first plurality of UI elements 806 correspond to different options (e.g., Option 1, Option 2, etc.) of a product included on the webpage (or the application layer 802). The different options may represent different configurations of the product (e.g., colors, sizes, etc.). The first plurality of UI elements 806 may be configured buttons that are selectable by the user; however, in other examples, the UI elements 806 may have a different configuration (e.g., text entry box, drop down menu, etc.). In some examples, the user can select or modify the first plurality of UI elements 806 to change the video content or video branch presented in the video player layer 804. Likewise, the second plurality of UI elements 808 may be configured as buttons, text entry boxes, drop down menus, or any other suitable UI elements. The user may select or modify each of the UI elements 806 to change the video content presented in the video player layer 804 and/or content displayed on the webpage (or the application layer 802).

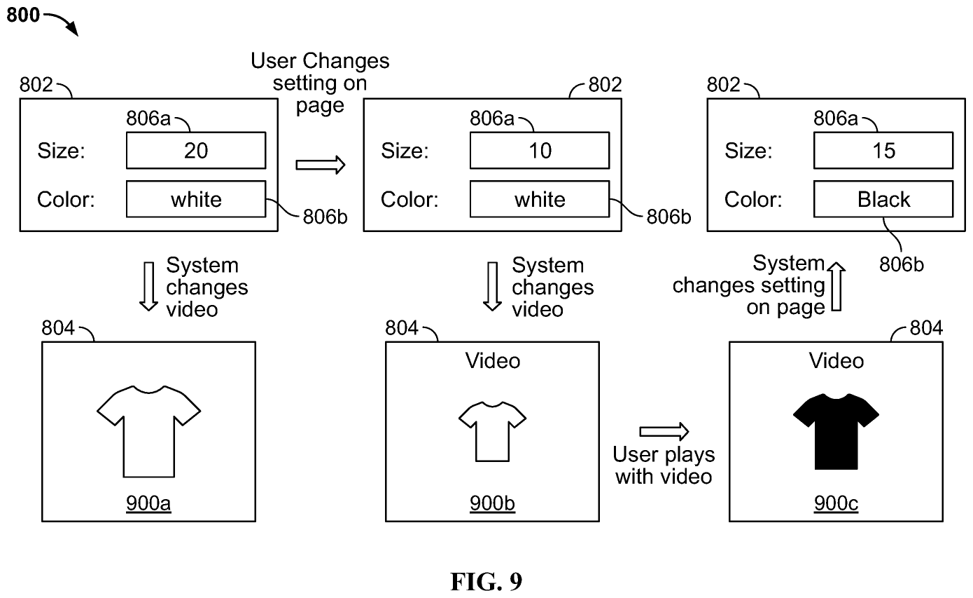

FIG. 9 illustrates an example user interaction sequence corresponding to the integrated video player 800. The illustrated example corresponds to an embodiment of the integrated video player 800 configured for an e-commerce application or website (e.g., Amazon, Walmart, etc.). In one example, the first plurality of UI elements 806 of the application layer 802 includes a first UI element 806a corresponding to a product size and a second UI element 806b corresponding to a product color. In some examples, the product is a shirt. As shown, the user may interact with the first UI element 806a to select a product size (e.g., “20”) and the second UI element 806b to select a product color (e.g., “white”). In response, the video player layer 804 automatically presents video content 900a corresponding to the selected product configuration (e.g., white shirt, size 20). The user can adjust the UI elements 806a, 806b to change the video content displayed in the video player layer 804. For example, in response to the user selecting a different product size (e.g., “10”) via the first UI element 806a, the video player layer 804 automatically presents video content 900b corresponding to the new product configuration (e.g., white shirt, size 10). Likewise, the user can interact with the video content to adjust the product configuration. In one example, the user can interact with the video content via one or more UI elements (e.g., the second plurality of UI elements 806). In some examples, the user can interact directly with the video content (e.g., tapping on the product, re-sizing the product, etc.). For example, the user may interact the product within the video player layer 804 to change the size and color of the product. In response, the video player layer 804 can present video content 900c representing the new product configuration (e.g., black shirt, size 15) and the UI element 806a, 806b can be updated by the application layer 802 to reflect the new product configuration. While not shown, the application layer 802 or the video player layer 804 may include a button that enables the user to purchase the product or add the product to an online shopping cart with a desired product configuration. In some examples, the video content presented in the video player layer 804 can be selected or modified based on other types of user interactions. For example, while the user navigates the webpage (e.g., the application layer 802), the video content may update as the user is moving between different items or products (e.g., using a cursor, scrolling on a touchscreen, etc.).

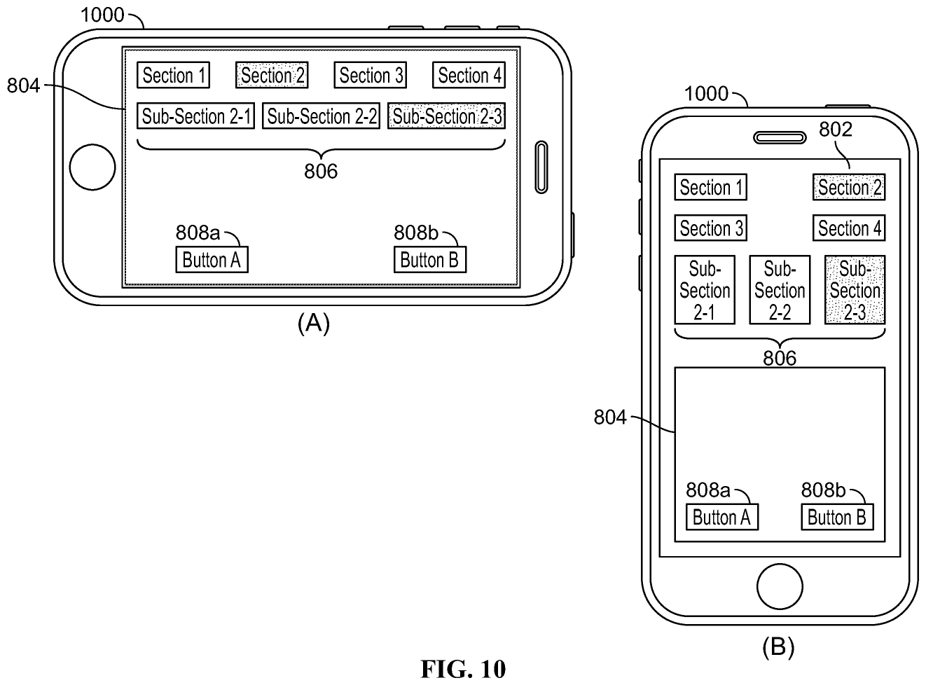

In some examples, the UI element configuration of the integrated video player 800 can be dynamically updated. For example, the configuration may change as the user changes the orientation of the device displaying the integrated video player 800. FIG. 10 illustrates several example orientations of a client device 1000 displaying the integrated video player 800. In one example, the client device is a mobile phone (e.g., smartphone); however, in other examples, the client device may be a tablet, computer, laptop, or other types of electronic devices. As shown, the client device 1000 can be positioned to have a first orientation A (e.g., landscape) and a second orientation B (e.g., portrait). In the first orientation A, the video player layer 804 can be scaled to cover the entire screen of the client device 1000. The first plurality of UI elements 806 of the application layer 802 can be arranged to overlay the video content presented by the video player layer 804 along with the second plurality of UI elements 808. In the second orientation B, the size of the video player layer 804 is adjusted such that the first plurality of UI elements 806 can be arranged in the application layer 802 above the video player layer 804 and the second plurality of UI elements 808. In other examples, the first plurality of UI elements 806 can be arranged in the application layer 802 below (or adjacent to) the video player layer 804.

As described above, the video content presented in the video player layer 804 can be updated based on changes to content displayed in the application layer 802, or vice versa. In one example, the application layer 802 and the video player layer 804 are configured to communicate via a two-way communication protocol. For example, layers 802, 804 may communicate using an application program interface (API). In some examples, the API includes a JavaScript library based on the “postMessage” iFrame framework. The communication protocol can include at least one queue such that messages can be sent between the layers 802, 804 without being lost or missed. The messages (or responses) can be sent between the layers 802, 804 in response to user interactions, before video content is displayed, after video content is displayed, and/or while the video content is being displayed (e.g., between frames of the video content). In one example, an embed URL associated with the integrated video player 800 (or the individual layers 802, 804) can be configured with parameters that are passed to the layers 802, 804. In some examples, the parameters (e.g., user ID, session ID, page view ID, etc.) are passed to the video player layer 804 such that video player layer 804 can provide initial video content corresponding to the current state of the application layer 802 and/or the user viewing the integrated video player 800. For example, the application layer 802 or webpage may have an embed URL link: https://eko.com/video/jks6gk/?userid=1234, where a user ID “1234” is provided to the video player layer 804.

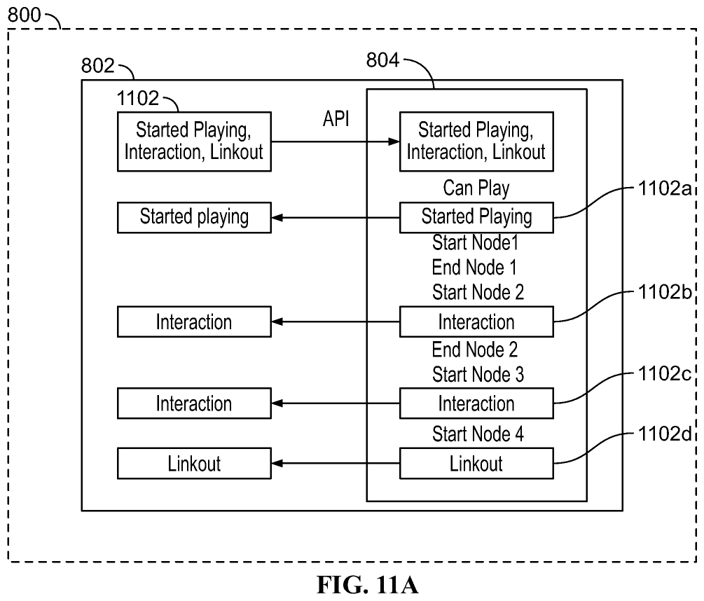

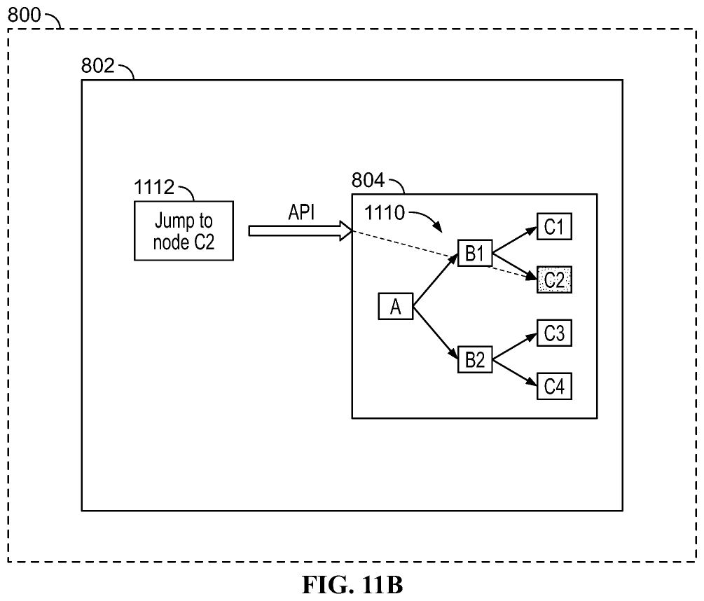

FIG. 11A illustrates an example communication sequence between the application layer 802 and the video player layer 804 of the integrated video player 800. In one example, the application layer 802 can send an event list 1102 to the video player layer 804. In some examples, the application layer 802 may send the event list 1102 during an initialization stage of the integrated video player 800. The event list 1102 may represent the events corresponding to the video player layer 804 that are determined to be relevant to the application layer 802 (or the content included in the application layer 802). For example, the event list 1102 can include events such as: “Started playing,” “interaction,” and “linkout.” The video player layer 804 can receive the event list 1102 and may send messages (or notifications) to the application layer when the various events occur. As shown, the video player layer 804 can send a first message 1102a to the application layer 802 via the API indicating that the video player layer 804 has started playing the video content (e.g., the interactive video). In some examples, the application layer 802 and/or content included on the application layer 802 is updated in response to each message received from the video player layer 804. The video player layer 804 may continue by starting a first node of the interactive video, ending the first node, and starting a second node of the interactive video. In one example, the user interacts with the interactive video during the second node. As such, the video player layer 804 sends a second message 1102b to the application layer 802 indicating the user has interacted with the interactive video. In some examples, the message 1102b provides information corresponding to the user interaction (e.g., a product configuration selected by the user). In certain examples, the application layer 802 can be updated based on the user interaction. The video player layer 804 may continue by ending the second node, starting a third node of the interactive video, and sending a third message 1102c to the application layer 802 indicating the user has interacted with the interactive video during the third node. In response to the user interaction during the third node, the video player layer 804 may start a fourth node of the interactive video. During the fourth node, the video player layer 804 sends a fourth message 1102d to the application layer 802 indicating a linkout event has occurred. In one example, the linkout event includes redirecting the integrated video player 800 (or one of the layers 802, 804) to an external link or webpage (e.g., an online shopping cart). In some examples, the linkout event can be triggered by a user interaction and/or by the content of the interactive video.

As described above, the video player layer 804 may send messages corresponding to events (e.g., user interactions) to the application layer 802. Likewise, the application layer 802 may send messages (or commands) via the API to the video player layer 804. For example, FIG. 11B illustrates an example command sent from the application layer 802 to the video player layer 804 of the integrated video player 800. In one example, the video player layer 804 is configured to play an interactive video 1110 having a plurality of nodes (e.g., Node A, Node B1, Node B2, etc.). The application layer 802 can send a command 1112 to the video player layer 804 before the interactive video 1110 is started, after the interactive video 1110 has ended, and/or while the interactive video 1110 is playing. In some examples, the command 1112 corresponds to a node of the interactive video 1112. For example, the command 1112 may instruct the video player layer 804 to jump or seek to node C2. In one example, the command 1112 is sent in response to a user interaction after viewing the video content associated with node B1; however, in other examples, the command 1112 may be sent at different times (e.g., after the user has viewed video content associated with node A). It should be appreciated that messages or commands can be exchanged between the application layer 802 and video player layer 804 in a synchronous or asynchronous manner.

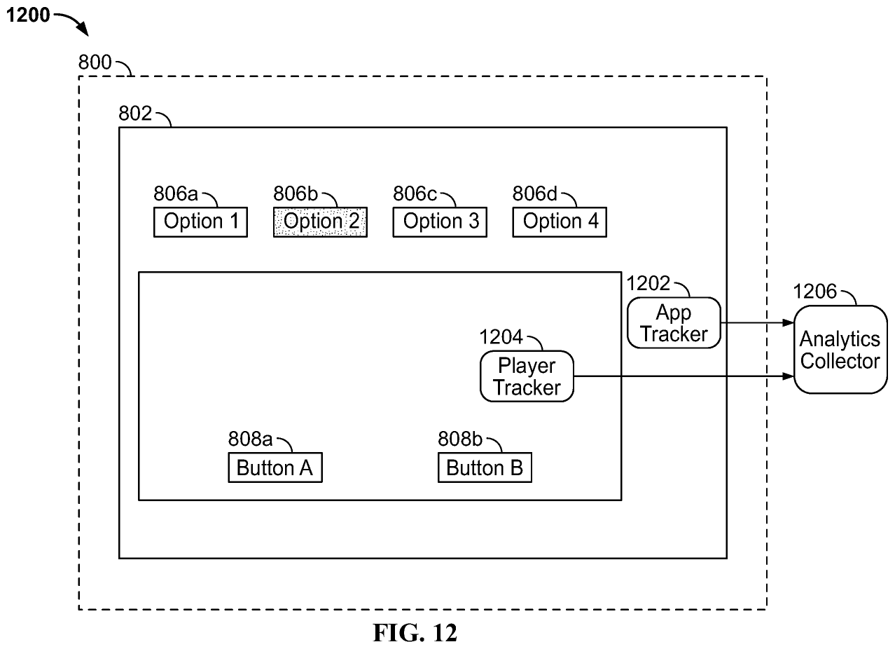

In some examples, analytics can be collected from both the application layer 802 and the video player layer 804 of the integrated video player 800. FIG. 12 illustrates an analytics platform 1200 including the integrated video player 800. In one example, the application layer 802 includes an application analytics tracker 1202 and the video player layer 804 includes a player analytics tracker 1204. As shown, both the application analytics tracker 1202 and the player analytics tracker 1204 can communicate with an analytics collector 1206. In some examples, the application analytics tracker 1202 is configured to monitor and report user interactions and events associated with the application layer 802. For example, the application analytics tracker 1202 may send data to the analytics collector 1206 corresponding to user interactions with the UI elements 806, messages or commands sent to the video player layer 804, and other events associated with the application layer 802. Likewise, the player analytics tracker 1204 is configured to monitor and report user interactions and events associated with the video player layer 804. For example, the player analytics tracker 1204 may send data to the analytics collector 1206 corresponding to user interactions with the UI elements 808, messages sent to the application layer 802, and other events associated with the video player layer 804.

In some examples, the platform 1200 is configured to execute one or more analytical programs (referred to as analytics) on the application layer 802 and/or the video player layer 804. For example, the platform 1200 may execute analytical programs on the interactive video, webpage, and/or app page to monitor and/or collect data on user interactions (e.g., selections, purchases, etc.). For example, this data can be used for marketing, product optimization, inventory optimization, etc. The data can be used by the merchant to determine which products are selected more than others, interacted with more frequently and/or for longer amounts of time, and/or purchased more often. In some cases, the data can be used to determine configurations for existing and/or future interactive videos. The analytics may keep track of user interactions via a user ID, the session associated with the playing of the video via a session identification number, an item or product identification number, the URL, etc.

### Terminology

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A method for presenting an interactive video to a user, the method comprising:
providing an application layer including a plurality of user interface (UI) elements;
providing a video player layer integrated in the application layer and configured to present the interactive video to the user, the interactive video representing a product;
receiving, via a first UI element of the plurality of UI elements, a first user interaction indicating a selection of a first product option from a plurality of first product options;
sending at least one first message from the application layer to the video player layer in response to the first user interaction;
presenting, via the video player layer, first video content of the interactive video based on the at least one first message, wherein the first video content includes the product configured with the first product option;
receiving, via a second UI element of the plurality of UI elements, a second user interaction indicating a selection of a second product option from a plurality of second product options;
sending at least one second message from the application layer to the video player layer in response to the second user interaction; and
presenting, via the video player layer, second video content of the interactive video based on the at least one second message, wherein the second video content includes the product configured with the first product option and the second product option.

2. The method of claim 1, wherein the application layer and the video player layer are configured to communicate via an application program interface (API).

3. The method of claim 1, wherein the application layer content includes webpage content presented to the user.

4. The method of claim 1, wherein the plurality of second product options includes at least one product option that is different from the plurality of first product options.

5. The method of claim 1, further comprising:
dynamically modifying the first UI element based on the first user interaction to display first visual indicia representing the first product option; and
dynamically modifying the second UI element based on the second user interaction to display second visual indicia representing the second product option.

6. The method of claim 1, further comprising:
receiving, via the first UI element of the plurality of UI elements, a third user interaction indicating a selection of a third product option from the plurality of first product options;
sending at least one third message from the application layer to the video player layer in response to the third user interaction; and
presenting, via the video player layer, third video content of the interactive video based on the at least one third message, wherein the third video content includes the product configured with the second product option and the third product option.

7. The method of claim 1, further comprising:
receiving, via the video player layer, a third user interaction with the interactive video, the third user interaction corresponding to a selection of a third product option from a plurality of third product options; and
presenting, via the video player layer, third video content of the interactive video presentation based on the third user interaction, wherein the third video content corresponds to the third product option.

8. The method of claim 7, further comprising:
sending at least one third message from the video player layer to the application layer in response to the third user interaction.

9. The method of claim 8, further comprising:
dynamically modifying a third UI element of the application layer based on the at least one third message to display visual indicia, wherein the visual indicia represent the third product option.

10. The method of claim 8, further comprising:
dynamically modifying at least one of the first UI element and the second UI element based on the at least one third message to display visual indicia, wherein the visual indicia represent the third product option.

11. A system for presenting an interactive video to a user, the system comprising:
at least one memory for storing computer-executable instructions; and
at least one processor for executing the instructions stored on the memory, wherein execution of the instructions programs the at least one processor to perform operations comprising:
providing an application layer including a plurality of user interface (UI) elements;
providing a video player layer integrated in the application layer and configured to present the interactive video to the user, the interactive video representing a product;
receiving, via a first UI element of the plurality of UI elements, a first user interaction indicating a selection of a first product option from a plurality of first product options;
sending at least one first message from the application layer to the video player layer in response to the first user interaction;
presenting, via the video player layer, first video content of the interactive video based on the at least one first message, wherein the first video content includes the product configured with the first product option;
receiving, via a second UI element of the plurality of UI elements, a second user interaction indicating a selection of a second product option from a plurality of second product options;
sending at least one second message from the application layer to the video player layer in response to the second user interaction; and
presenting, via the video player layer, second video content of the interactive video based on the at least one second message, wherein the second video content includes the product configured with the first product option and the second product option.

12. The system of claim 11, wherein the application layer and the video player layer are configured to communicate via an application program interface (API).

13. The system of claim 11, wherein the application layer content includes webpage content presented to the user.

14. The system of claim 11, wherein the plurality of second product options includes at least one product option that is different from the plurality of first product options.

15. The system of claim 11, wherein the operations further comprise:
dynamically modifying the first UI element based on the first user interaction to display first visual indicia representing the first product option; and
dynamically modifying the second UI element based on the second user interaction to display second visual indicia representing the second product option.

16. The system of claim 11, wherein the operations further comprise:
receiving, via the first UI element of the plurality of UI elements, a third user interaction indicating a selection of a third product option from the plurality of first product options;
sending at least one third message from the application layer to the video player layer in response to the third user interaction; and
presenting, via the video player layer, third video content of the interactive video based on the at least one third message, wherein the third video content includes the product configured with the second product option and the third product option.

17. The system of claim 11, wherein the operations further comprise:
receiving, via the video player layer, a third user interaction with the interactive video, the third user interaction corresponding to a selection of a third product option from a plurality of third product options; and
presenting, via the video player layer, third video content of the interactive video presentation based on the third user interaction, wherein the third video content corresponds to the third product option.

18. The system of claim 17, wherein the operations further comprise:
sending at least one third message from the video player layer to the application layer in response to the third user interaction.

19. The system of claim 18, wherein the operations further comprise:
dynamically modifying a third UI element of the application layer based on the at least one third message to display visual indicia, wherein the visual indicia represent the third product option.

20. The system of claim 18, wherein the operations further comprise:
dynamically modifying at least one of the first UI element and the second UI element based on the at least one third message to display visual indicia, wherein the visual indicia represent the third product option.
